(19) United States
(12) Patent Application Publication
(10) Pub. No.: US 2026/0138823 A1
(43) Pub. Date: May 21, 2026

(54) ELONGATE MEMBER HAVING AT LEAST ONE TOOTHED BAR, STORAGE RACK COMPRISING SUCH AN ELONGATE MEMBER, AND TRANSPORT AND STORAGE SYSTEM COMPRISING SUCH A STORAGE RACK

(71) Applicant: EXOTEC PRODUCT FRANCE, CROIX (FR)

(72) Inventors: Alexis LEROUGE, HELLEMMES-LILLE (FR); Victor IGLA, HASNON (FR)

(73) Assignee: EXOTEC PRODUCT FRANCE, CROIX (FR)

(21) Appl. No.: 19/120,966

(22) PCT Filed: Oct. 5, 2023
(86) PCT No.: PCT/EP2023/077626

§ 371 Date: Apr. 14, 2025

(30) Foreign Application Priority Data
Oct. 13, 2022 (FR) 2210527

(51) Int. Cl. B65G 1/04

(52) U.S. Cl. CPC B65G 1/04

(57) ABSTRACT

An elongate member having at least one toothed bar intended to mesh with a cogwheel pivoting around a rotation axis of the cogwheel. The elongate member may be a beam formed by a metal profile having a tubular or semi-tubular cross-section, wherein the first teeth are formed by folded tabs which are produced by folding the material of the metal profile coming from a series of openings in a wall of the profile, the tabs being distributed along the lengthwise direction of said elongate member, said tabs projecting from said wall, on one side of the wall.

### TECHNICAL FIELD

This disclosure relates to the field of warehouses which include storage racks. A storage rack typically includes a vertical structure, formed by an assembly of vertical uprights, often in the form of vertical metal profiles.

Bracing devices, such as crosspieces or the like, typically connect the uprights. These bracing devices are distributed over the height of the vertical structure and ensure the stability of the storage rack structure.

In warehouses, these storage racks are intended to accommodate and store items, said items then being grouped together to form orders; these orders are subsequently sent to an end customer by means of road or rail transportation, or any other type of transportation, or taken out of the warehouse to be collected directly by the end customer at a “drive”.

Within their structure, storage racks define storage locations, also called cells. These cells are intended to receive bins or more generally containers, in which items are placed and stored.

To this end, pairs of mechanical interfaces, typically in the form of brackets, are secured to the uprights, to ensure that the different loads at the level of the different cells are centered and supported.

The present disclosure relates more particularly to the field of storage and transport systems comprising such storage racks, and served by a transport system comprising automatic guided vehicles, the vehicles being configured to pick up and drop off items from/into said storage racks. Such storage systems are called ASRS, which stands for Automated Storage and Retrieval System.

Automatic guided vehicles, hereinafter referred to by their abbreviation AGV, are robots that move autonomously without human intervention.

In the case of this domain, the AGVs move in the storage warehouse, following the height of the storage rack, thanks to the toothed bar carried by the elongate member. Said AGVs can also move in at least one direction, or even both directions, of a horizontal surface which can typically be the warehouse floor.

### PRIOR ART

Such storage systems are disclosed in particular by document WO 2019/072432 of the present Applicant.

As disclosed by this document WO2019/072432, automatic guided vehicles are configured to pick up containers of products or of articles supported by the brackets in the storage racks, and transport them to another location, typically another storage location, or to an order preparation station where said articles are gathered, typically so as to constitute an order for an end customer.

To this end, the automatic guided vehicles can also move vertically on storage racks.

According to this latter configuration, said AGVs can have a chassis equipped with climbing means. Typically, these means include motorized cogwheels of the vehicle that are configured to mesh with the links of a substantially tensioned roller chain, or with the teeth of a toothed bar extending along the uprights of the storage racks.

As disclosed by WO 2019/072432, the chassis of the automated guided vehicle typically also has a prehension device comprising a mobile support, movable relative to the chassis, which is configured to move from a retracted loading position for loading a container (typically a bin) onto the vehicle chassis in which the support is typically housed on the chassis, and to a deployed unloading position in which the mobile support extends cantilevered with respect to the chassis to unload/drop the container, typically onto one of the pairs of brackets of the storage rack.

Thus, AGVs have locomotion and orientation means, making them capable of moving in three dimensions. In addition to the two plane dimensions generally associated with the ground on which the AGVs move, there is a third vertical dimension associated with the storage racks on which the AGVs are able to climb and descend. Examples of this technology can be found, among others, in WO 2018/189110, and also in WO 2020/056175, EP 3 288 865 and WO 2022/089811.

In such a piece of prior art, the toothed bars (or tensioned chains), vertically fastened to the storage racks, are additional equipment to the profiles of the storage rack uprights, which require specific fastening members for their connection to the upright profiles. Assembling them to the profile often requires compliance with a rigorous assembly procedure when fastening them to the uprights. Document FR 3.103.368 A1 is an example of such an assembly procedure.

As understandable from the assembly steps of document FR 3.103.368 A1, in particular when the engaging member fastened to the upright is a chain, such an assembly procedure requires compliance with a specific sequence of the assembly procedure steps, including adjusting different dimensions. These assembly procedures are typically complex, lengthy and therefore both costly and time-consuming. In addition, they require qualified operators for their implementation.

Chains have an additional disadvantage compared to toothed bars, in that they slacken and therefore get longer. Chains require regular maintenance to replace them, or the set of teeth of the cogwheel will wear out prematurely.

In order for the transmission to require less maintenance, the skilled person prefers toothed bars to chains.

These toothed bars are typically made of plastic materials. The toothed bar extending over the height of the upright is typically produced with a series of several injection-molded toothed bar sections. However, injection molding machines are a costly investment, and their operation also requires significant energy demand.

An additional inconvenient related to the injection molding manufacturing method is that the injection molded plastic parts do not have sufficiently identical dimensions, which can cause breaches in the continuity of the toothed bar between the different sections of the toothed bar. These breaches cause shocks over the vertical movement of the AGV: this results in a significant increase in the noise level in the warehouse and these shocks can also have direct mechanical consequences on the integrity of the robots.

According to the present Applicant, there has long been a need for a transport and storage system offering a better cost-performance ratio, increased precision, and even greatly simplifying the procedures for mounting the toothed bars (or tensioned chain) to the storage racks.

### SUMMARY

This disclosure significantly improves this situation.

The present disclosure relates, according to a first aspect, to an elongate member having at least one toothed bar intended to mesh with a cogwheel pivoting around a rotation axis of the cogwheel, said at least one toothed bar comprising first teeth distributed along a lengthwise direction of said elongate member, intended to mesh with second teeth over a diameter of the cogwheel.

According to this disclosure, the elongate member is a metal profile, and wherein the first teeth are formed by folded tabs which are produced by folding the material of the metal profile coming from a series of openings in a wall of the profile distributed along the lengthwise direction of said elongate member, said tabs projecting from said wall, on one side of the wall.

The following optional features may be implemented alone, and in combination with the present disclosure according to the first aspect.

According to an embodiment, the metal profile can advantageously be a structural beam having a tubular or semi-tubular cross-section. According to such an embodiment, the profile may comprise longitudinal fold lines extending parallel to each other along the elongate member defining the angles of the profile section. Such a structural tubular or semi-tubular profile can typically be produced by roll forming techniques.

A tubular cross-section beam means a beam whose metal profile has a closed cross-section, for example a rectangular section. A semi-tubular cross-section beam means a beam whose metal profile has an open cross-section, for example a U-shaped section.

According to another embodiment the metal profile is a metal sheet such as a blade in which the tabs are formed, namely a non-structural component compared to a beam having a tubular or semi-tubular cross-section. Such an elongate member can be directly produced by cutting and stamping so as to produce the tabs, without requiring a roll forming operation.

According to an embodiment, the folded tabs can be inclined in the same direction relative to the longitudinal direction of the elongate member, the tabs defining dorsal surfaces facing the openings, and functional bearing surfaces, opposite the dorsal surfaces, configured to engage the second teeth of the cogwheel to allow a thrust force of the cogwheel on said at least one toothed bar in a first advancement direction along the toothed bar, and wherein the teeth of said at least one toothed bar are devoid of functional bearing surfaces configured to allow a thrust force of the cogwheel on said at least one toothed bar in a second advancement direction, opposite the first advancement direction.

According to an embodiment, the tabs are adjacent the wall of the profile having said openings, said tabs being adjacent by transverse fold lines oriented substantially transversely to the longitudinal direction of the elongate member, in particular transversely to the transverse fold lines when the beam profile is of tubular or semi-tubular cross-section, the transverse fold lines being parallel to each other, distributed along the length of said elongate member and wherein the tabs have at least one main part each extending in a direction D3, perpendicular to the transverse fold line, from a proximal end of the transverse fold line to a distal end by defining a functional bearing surface, configured to engage with the second teeth of the cogwheel.

According to an embodiment, the elongate member can be arranged so that the tabs of said at least one toothed bar are oriented in the downward direction of said elongate member, from said proximal end to the free distal end, said functional bearing surfaces arranged above the tabs, configured so that the gravity exerted on the cogwheel holds at least one of the second teeth of the cogwheel against the functional bearing surface of one of the tabs of the first teeth of the elongate member.

According to an embodiment, the angle S3 between the direction D3 of the main portion of the tab, and the longitudinal direction of the elongate member can be less than 90°, preferably between 50° and 80°, typically 70° and so that the complementary pressure angle α is typically between 10° and 40°, for example 20°.

According to one embodiment, the tab can comprise, in addition to said main portion defining the functional bearing surface, at least one supporting portion, extending the main portion laterally on one side of the main portion, or two supporting portions extending the main portion laterally respectively on both sides of the main portion. The supporting portion, or each of the two supporting portions can extend in projection from the main portion of the tab, on the side opposite the functional bearing surface to constitute a reinforcement means between the main portion and the profile, the reinforcement means opposing the tab bending when the upper functional bearing surface undergoes a force transmitted by the second teeth of the cogwheel.

According to an embodiment, the supporting portion, or all or part of the supporting portions can connect the main portion of the tab to the wall of the profile provided with the openings which is a flat wall.

According to an embodiment, the wall of the profile provided with the openings can be partially contained in a plane by defining a flat wall, the wall provided with the openings being extended on either side of the tabs, by two side walls extending in projection from the flat wall, projecting on the same side as the tabs, the two side walls adjoining the tabs, and wherein the two supporting portions respectively connect the main portion to said two side walls.

The present disclosure relates to a storage rack comprising a vertical structure comprising several uprights extending vertically, parallel to each other, and held together by a bracing system, and wherein the uprights are formed in whole or in part by elongate members according to the present disclosure.

Advantageously and according to a second aspect, the elongate member (or each elongate member) can be formed by a metal profile which is the beam having a tubular or semi-tubular cross-section conferring structural resistance on the upright which is a single-piece component, typically produced by roll forming and stamping cutting techniques.

Alternatively and according to a third aspect, the present disclosure does not exclude manufacturing in several parts and thus relates to an upright assembly comprising:
an elongate member according to the present disclosure, wherein the profile is the metal sheet provided with said tabs of said at least one toothed bar,
a second upright profile, structural, typically tubular or semi-tubular, and wherein the metal sheet of the elongate member provided with the toothed bar is fastened longitudinally to the second structural upright profile.

Fastening the metal sheet provided with the toothed bar and the second profile can be achieved by fastening members, such as rivets, by welding, by crimping.

According to a fourth aspect, the present disclosure relates to a storage rack comprising a vertical structure comprising several uprights extending vertically, parallel to each other, and held together by a bracing system, and wherein the uprights are formed in whole or in part by upright assemblies according to the present disclosure.

According to a fifth aspect, the present disclosure relates to a transport and storage system comprising a storage rack according to the present disclosure (according to the second aspect or the fourth aspect) and at least one vehicle comprising a chassis, incorporating climbing means, comprising one or more motorized cogwheels configured to perform the movement of the vehicle along the uprights of the vertical structure of the storage rack, upwards or downwards, by transforming a rotational movement of the cogwheel(s) into a movement of the vehicle along said elongate member(s) by the first teeth of said at least one toothed bar meshing with the second teeth of the cogwheel.

The system according to the fifth aspect can comprise the following optional features, alone or in combination:
According to an embodiment, the storage rack can be configured to support a plurality of receptacles, said storage rack comprising a plurality of pairs of mechanical interfaces which are fastened to the uprights, distributed along the height of the rack to form several storage cells, each pair of interfaces comprising:
   a first interface fastened to at least two uprights of the vertical structure, cantilevered from the two uprights
   a second interface fastened to at least two other uprights of the vertical structure, cantilevered from the other two uprights. Supporting portions of the first interface and the second interface are oriented towards each other in cantilevered manner from the uprights, configured to provide support for a receptacle supported by the two supporting portions of the two interfaces on both sides of the receptacle. The vehicle may comprise a deployable loading/unloading system configured to:
load a receptacle from a first retracted position above the chassis to a second deployed position for which the receptacle is simultaneously bearing on the first interface and the second interface, or
take out a receptacle from the second position bearing on the first interface and the second interface of a pair of interfaces and load it into the first retracted position.

According to one embodiment, the vehicle comprises an uncoupling mechanism configured to move the cogwheel(s) of the climbing means of the vehicle from a coupled position for which the first teeth of the elongate member and the second teeth of the cogwheel are engaged, to a uncoupled position for which the cogwheel(s) provided with the second teeth, on the one hand, and the elongate members provided with the first teeth, on the other hand, are spaced apart with escapement between the first teeth and the second teeth. The vehicle can comprise rolling means for rolling on a horizontal surface, allowing the vehicle to move on the horizontal surface in said uncoupled position, once the vehicle is separated from the vertical structure of the storage rack.

According to an embodiment, the cogwheel is articulated along the rotation axis on a support of the vehicle,
and wherein the vehicle is equipped with a guiding system comprising a guiding member, such as a bearing roller, or a sliding pad, cooperating with a guiding wall of said profile of said elongate member,
and wherein the guiding system is configured so that the cooperation of the guiding member against the guiding wall ensures that the first teeth of said at least one toothed bar and the second teeth of the cogwheel are kept in engagement.

Finally, the present disclosure relates, according to a sixth aspect, to a method for manufacturing an elongate member according to the present disclosure, an upright assembly according to the present disclosure, or a storage rack according to the present disclosure, or a transport and storage system according to the present disclosure, wherein the profile forming the elongate member is produced, possibly having a tubular or semi-tubular cross-section, by roll forming techniques, and said folded tabs are produced from the material of the openings in the wall of the profile by cutting and stamping techniques.

### BRIEF DESCRIPTION OF THE DRAWINGS

Other features, details and advantages will become apparent from reading below detailed description, and from the attached drawings, in which:

FIG. 1 is a view of an elongate member according to a first embodiment:
on the right, an elongate member according to this disclosure, in the form of a profile extending rectilinearly and comprising a wall having first teeth, in two parallel series forming two toothed bars parallel to each other, wherein each series of teeth extends longitudinally with respect to the elongate member, the first teeth being formed by folded tabs forming openings through said wall, produced by cutting and stamping techniques,
on the left, of a sectional view passing through a vertical plane to the wall having the folded tabs of the toothed bar, the view illustrating a cogwheel belonging to an AGV (not shown in the figure) and being provided on its periphery with the teeth of the cogwheel, called second teeth, engaging with upper functional bearing surfaces of the tabs that form the first teeth of the toothed bar.

FIG. 1a is a detailed view of the set of teeth of the cogwheel belonging to a robot (not shown in said figure), each tooth having two flanks, on either side of an apex of the tooth, wherein the flanks each have a tooth profile shaped as a circle involute, capable of rolling on the teeth of the toothed bar.

FIG. 1b is a schematic view of the U-shaped cutout in the wall of the profile provided with the openings, allowing a tab to be provided, the U-shaped cutout comprising a lower cutting line, and two lateral cutting lines, allowing, during stamping, the formation of the tab by a transverse fold line connecting the two ends of the U of the cutout.

FIG. 2 is a perspective view of a profile of an elongate member according to a second embodiment, providing improved wear resistance compared to the design of FIG. 1.

FIG. 2a is a cross-sectional view of the improved profile of FIG. 2, along a plane perpendicular to the axis of the profile, illustrating the cross-section of the profile including the various longitudinal fold lines of the profile, as well as schematically its cooperation with a cogwheel rotatably mounted on a support belonging to a robot (not shown here), the second teeth of which mesh with the folded tabs forming the first teeth of the elongate member, the view notably illustrating a guiding member (in the form of a wheel) articulated to the support, along an rotation axis extending in parallel to the rotation axis of the cogwheel, and cooperating in guiding with a guiding wall of the profile to ensure that the teeth are kept engaged with each other (first teeth and second teeth).

FIG. 2b is a detailed view of a folded tab of the profile according to FIG. 2, which has a main portion, forming a functional bearing surface, intended to come into contact with one of the second teeth of the cogwheel (not shown), in particular a rolling contact between the functional bearing surface and a tooth profile, shaped as a circle involute, of the set of teeth of the cogwheel, and also two supporting portions, laterally extending the main portion of the tab; each of the two supporting portions projects from the main portion of the tab, on the side opposite the functional bearing surface, the two supporting portions forming with the main portion an arch to constitute a means of reinforcement between the main portion and the profile. Such a reinforcement means opposes the tab bending when the upper functional bearing surface undergoes a force transmitted by the second teeth of the cogwheel. In particular, the two supporting portions connect the main portion, respectively on both sides of the main portion, to the wall of the profile provided with the openings, the wall being flat and substantially parallel to the longitudinal axis of the elongate member.

FIG. 2c is a sectional view, along a plane passing through a longitudinal axis of the elongate member, illustrating the folded tabs in cross-section, from their proximal end adjoining transverse fold lines, to their free distal end, the tabs all being folded downwards, defining upper functional bearing surfaces.

FIG. 2d is a schematic view of the cutout in the wall of the profile provided with the openings, allowing a tab to be provided, the cutout consisting of a lower cutting line, allowing, during stamping, the formation of the tab by a transverse fold line and two lateral fold lines, respectively connecting one end of the transverse fold line to a lower cutting line.

FIG. 3 is a view of the wheel and toothed bar system which comprises an elongate member according to FIG. 2, meshing with a cogwheel belonging to a robot (not shown).

FIG. 4 is an alternative to FIG. 2b for which the two lateral supporting portions of the tab connect the main portion, not to the flat wall provided with the openings from which the folded tabs originate as illustrated in FIG. 2b, but to two substantially parallel side walls, extending in projection from a flat portion of the wall provided with the openings, projecting on the same side as the tabs, the two side walls adjoining the tabs, the openings extending not only through the flat wall, but side walls.

FIG. 5 is a front view of a storage rack having a vertical structure comprising uprights formed by profiles of the elongate members according to the present disclosure, but also a plurality of pairs of mechanical interfaces which are fastened to the uprights, distributed along the height of the storage rack to form several loading/unloading cells, wherein each pair of interfaces comprises:
a first interface fastened to at least two uprights of the vertical structure, cantilevered from the two uprights
a second interface fastened to at least two other uprights of the vertical structure, cantilevered from the other two uprights.

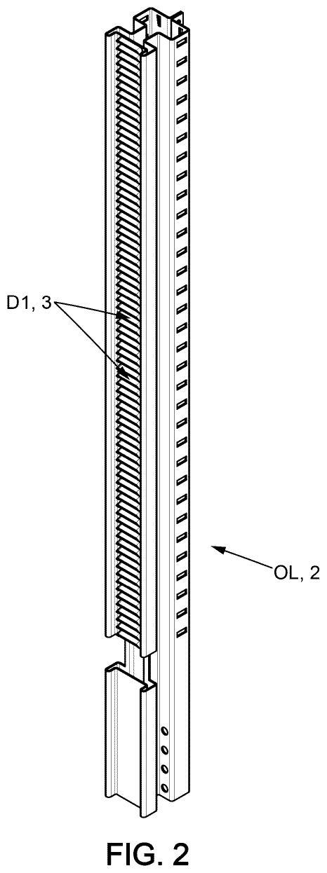

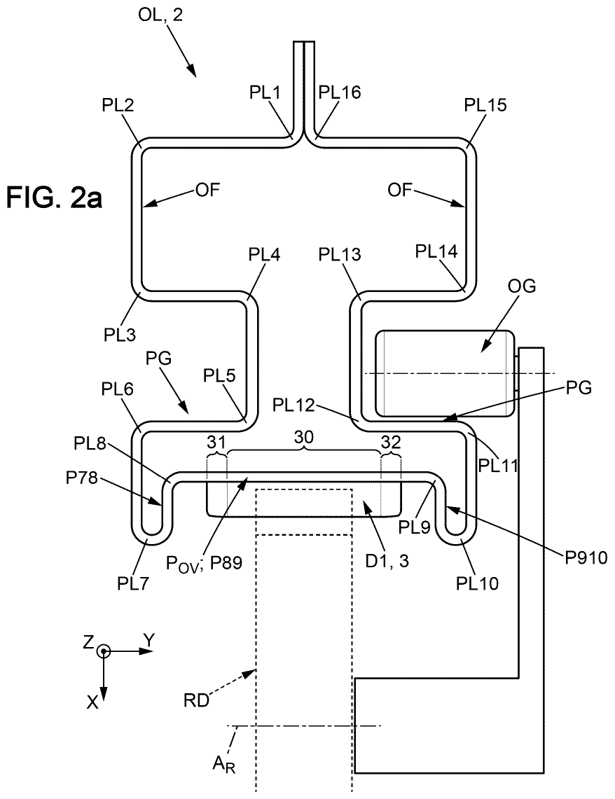

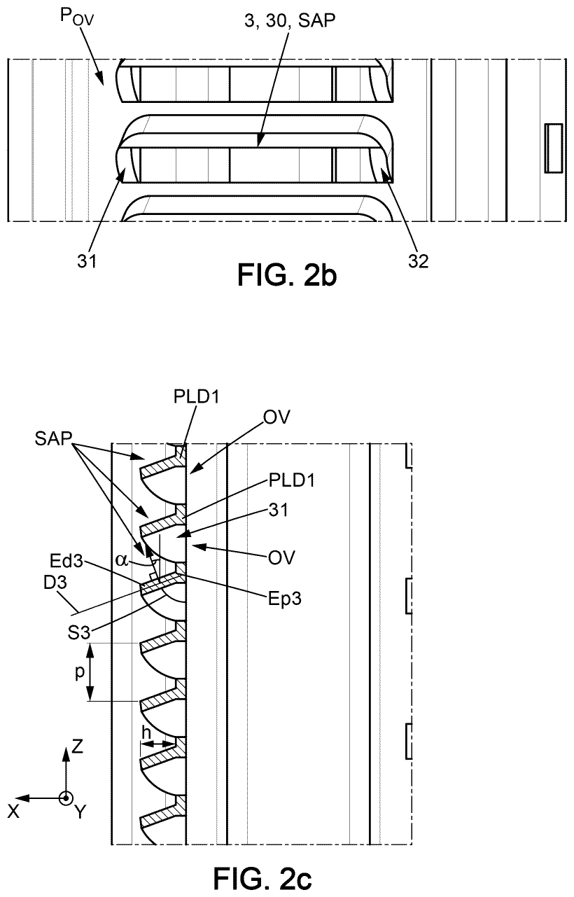

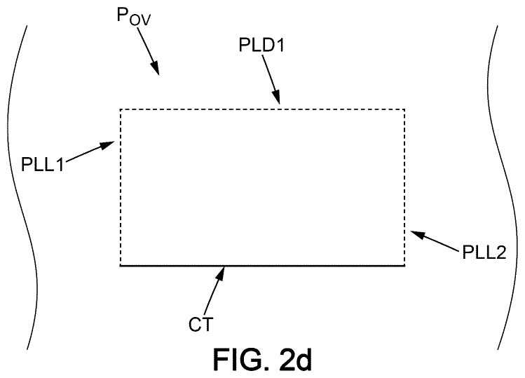

FIG. 6 is a top view illustrating two storage racks, spaced apart from each other, along the X direction, forming an aisle between the two storage racks, each storage rack being equipped with the uprights in the form of profiles of the elongate members according to FIG. 2.

FIG. 7 is a perspective view of an automatic guided vehicle comprising four motorized cogwheels, which respectively mesh with the teeth of the toothed bars of four elongate members to ensure the upwards or downwards movement of the vehicle along the beams forming the uprights of the storage racks.

### DESCRIPTION OF THE EMBODIMENTS

The drawings and description below contain, for the most part, elements of a definite nature. They may therefore not only serve to better understand the present disclosure, but also contribute to its definition, where appropriate.

The present disclosure relates, according to a first aspect, to an elongate member OL having at least one toothed bar intended to mesh with a cogwheel RD pivoting around a rotation axis AR of the cogwheel.

To this end, said at least one toothed bar comprises first teeth D1, distributed along a lengthwise direction of said elongate member, and the cogwheel RD comprises second teeth D2 over a diameter of the cogwheel.

As a rule, the teeth of the set of teeth of the toothed bar are designated by “first teeth”, referenced D1, and the teeth of the set of teeth of the cogwheel RD by “second teeth”, referenced D2, without the interpretation thereof being limited due to the use of “first” or “second” which have the sole purpose of differentiating the teeth of the toothed bar and the teeth of the cogwheel.

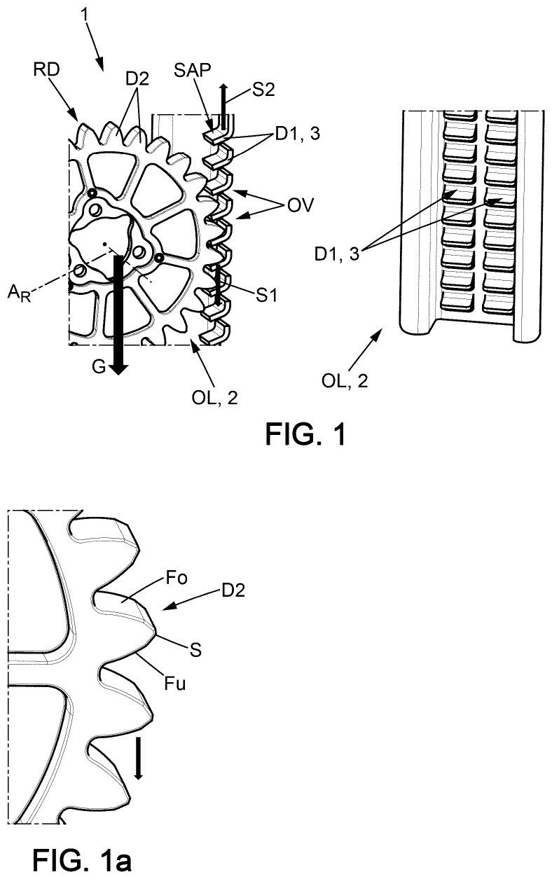

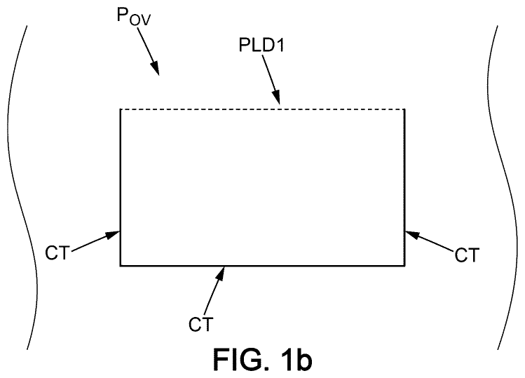

Generally, the elongate member may comprise a single toothed bar formed from a set of teeth formed by a series of tabs 3, and as, for example, illustrated for information purposes in FIG. 2. According to other possible embodiments, the elongate member can carry several toothed bars in parallel directions, for example two toothed bars, constituted by two series of tabs 3, extending according to two directions parallel to each other, and as for example visible in FIG. 1. These two toothed bars can in particular allow two cogwheels belonging to two separate AGVs to move simultaneously on the same profile.

The cogwheel and said at least one toothed bar form a cogwheel and toothed bar system 1 which is configured to transform a rotational movement of the cogwheel RD into a movement along said elongate member OL, by meshing the second teeth of the cogwheel RD and the first teeth D1 of said at least one toothed bar.

In the implementation mode of the present Application, the cogwheel is mounted on the AGV, while said at least one toothed bar is secured to the storage rack. This cogwheel meshes with said at least one toothed bar of the elongate member in order to allow the vertical movement of said AGV up or down the storage racks. This disclosure is not limited to this application and may cover any other application requiring a cogwheel and toothed bar system, in particular by providing an optimized cost-performance alternative.

The elongate member OL can be typically rectilinear so that the movement along the elongate member OL is a rectilinear movement. The present disclosure does not exclude that the elongate member is not rectilinear, and for example that it has a bend. The movement along the elongate member then copies the curvature radius of the elongate member.

Notably, according to the present disclosure, the elongate member is formed by a metal profile, and preferably a beam having a tubular or semi-tubular cross-section. Such a metal beam profile, in particular when tubular or semi-tubular, may typically be produced from a metal sheet or a sheet metal, for example a steel sheet, by forming techniques, such as roll forming techniques. The metal used can typically be steel or aluminum.

A tubular cross-section beam is a beam whose metal profile has a closed cross-section, for example a rectangular section. A semi-tubular cross-section beam is a beam whose metal profile has an open cross-section, for example a U-shaped section.

Roll forming is a technique that provides continuous deformation by cold forming from a metal strip in sheets or typically in thin coils; the strip is typically 0.5 to 2 mm thick. The strip can take the form of a coil of sheet metal. The coil is unrolled, then punched to create the cutouts in the wall of the profile. Successive wheels gradually bend the strip in its unrolling direction to form the profile cross-section. A machine cuts this continuous profile into different sections at the desired lengths.

The thickness of the metal sheet can typically be between 0.5 mm and 2 mm. The tubular or semi-tubular cross-section of the metal profile ensures the performance of the beam in terms of rigidity, bending resistance, and even torsional resistance of the beam.

FIG. 2a shows, as a non-limiting example, a profile having a tubular cross-section, i.e. a closed cross-section. The present disclosure also applies without difficulty to profiles having a semi-tubular cross-section, that is to say an open cross-section.

Also notably, the first teeth D1 are formed by folded tabs 3 which are produced by folding the material of the metal profile coming from a series of openings OV in a wall P_{OV} of the profile, the openings being distributed along the lengthwise direction of said elongate member OL.

Generally, and as illustrated for information purposes in FIG. 1, said tabs 3 extend projecting from said wall, on one side of the wall. These folded tabs 3 constituting the first teeth D1 of said at least one toothed bar are advantageously made of a single piece with the metal profile and can advantageously be produced by cutting and stamping techniques.

The elongate member according to the present disclosure is therefore advantageously a single-piece element, which can typically be produced at low cost from a sheet of metal by roll forming techniques, as well as cutting and stamping.

This single-piece element advantageously carries, at least according to a first embodiment, simultaneously:
a structural beam function, with controlled mass in that the beam formed from a profile, tubular or semi-tubular, is hollow, but also,
a toothed bar function.

Such an elongate member thus finds a particular application, at least according to a first embodiment, as a structural upright of a storage rack structure comprising an integrated toothed bar, typically produced by stamping a sheet metal, and typically as a replacement for an assembly comprising an upright profile, on the one hand, and a toothed bar (or a tensioned chain), on the other hand, the upright profile and the toothed bar (or tensioned chain) according to this prior art typically illustrated by document WO 2019/072432 A1 being separate components, requiring to be fastened to each other by specific fastening systems.

The elongate member according to this first embodiment of the present disclosure provided with the dual beam/toothed bar function is a notable progress compared to this piece of prior art in terms of:
cost-performance ratio due to simplification,
cost-to-mass ratio, due to the elimination of the tensioned chain or the toothed bar which typically have a mass greater than the toothed bar tabs according to the present disclosure.

A design of the toothed bar in which a sheet metal is stamped also allows for greater precision in the production of the set of teeth of the toothed bar, compared to manufacturing the toothed bar in different injection-molded plastic sections. Such precision improves the operation of the cogwheel/toothed bar transmission, and reduces operating noise.

The elongate member according to the present disclosure provides a further notable advance during the assembly of the storage rack in that it effectively eliminates the need for adjustment between the beam profile, on the one hand, and the toothed bar on the other hand, which form a single-piece element produced during manufacture.

It is to the Applicant's credit to have identified that, in the prior art described in the introduction, namely comprising vehicles (or motorized carriages) provided with motorized cogwheels, meshing with vertical toothed bars secured to the uprights of the storage rack, as for example disclosed by WO 2019/072432 A1, only the upper flanks of the teeth of the toothed bar come into contact with the teeth of the cogwheel, and even more so always along a single flank (or a tooth profile shaped as a circle involute) of each tooth of the cogwheel, and, due to the gravity exerted on the vehicle and the cogwheel, which always maintains this contact, that the motorized vehicle provided with the motorized cogwheel moves upwards or downwards along the uprights of the storage rack, following the two opposite rotation directions of the cogwheel.

Furthermore, and based on this observation, it is to the Applicant's credit to have designed a toothed bar whose teeth have only one functional bearing surface per tooth ensuring thrust of the cogwheel in a single advancement direction (hereinafter referred to as “first advancement direction”), and unlike in the prior art for which each tooth of the toothed bar has, on either side of the tooth apex, two functional bearing surfaces configured to ensure movement of the cogwheel respectively by thrusts allowing two opposite advancement directions.

Due to this simplification, the present disclosure allows for manufacturing by stamping which requires deforming much less metal compared to a manufacturing process which would require producing by stamping two functional bearing surfaces per tooth to allow thrusts in two opposite advancement directions.

The present disclosure is notable in that it preferably has a single functional bearing surface per tooth of said at least one toothed bar, which advantageously allows manufacturing by stamping, with a non-negligible tooth height “h”, and for tooth pitches “p”, even of small dimensions. In fact, manufacturing a set of teeth by stamping, with two functional bearing surfaces per tooth, would be limited to a set of teeth having a very low height and/or a set of teeth having a large pitch.

The pitch of the set of teeth p, illustrated in FIG. 2c, namely the distance separating two functional bearing surfaces SAP of two first teeth D1 can typically be between 5 mm and 15 mm, such as 10 mm.

The height h of the first tooth D1, namely the dimension following a foot of the tooth, perpendicular to the longitudinal axis of the elongate member, can typically be between 3.5 mm and 11 mm, such as 7 mm.

According to the present disclosure, the elongate member thus preferably extends vertically or at least in an inclined manner, so that the second teeth D2 of the cogwheel always come into contact with a functional bearing surface of the tabs, which is then greater, under the effect of gravity G which is exerted on the cogwheel (as illustrated for information purposes in FIG. 1) or on a motorized carriage incorporating the cogwheel, in particular a motorized carriage of an AGV, regardless of the direction of movement of the motorized carriage, upwards or downwards, depending on the rotation direction of the cogwheel RD, and always with only one of the two flanks of the second tooth D2 bearing.

In operation, the opposite flanks Fo of the second teeth D2 located, relative to the apex S of the tooth, opposite these operating flanks Fu, do not come into contact with the tabs 3. The first teeth D1 of the toothed bar are advantageously devoid of a lower functional bearing surface configured to exert such contact.

Although the opposite flanks Fo to the operating flanks Fu of the cogwheel never come into contact with the toothed bar during operation, under the effect of gravity, each second tooth of the cogwheel can have two tooth profiles per tooth, and typically a tooth profile shaped as a circle involute.

Such a design allows the cogwheel to be mounted in both possible directions while always ensuring meshing with the set of teeth of said at least one toothed bar, avoiding errors in assembling the vehicle, and in comparison to the case where the cogwheel only has one tooth profile per tooth to mesh with the toothed bar.

Thus, preferably, and as illustrated in FIG. 1, the folded tabs 3 are inclined in the same direction relative to the longitudinal direction of the beam 2.

Generally, preferably, the folded tabs 3 define dorsal surfaces facing the openings OV, and functional bearing surfaces SAP, opposite the dorsal surfaces, configured to engage, preferably rolling, the second teeth D2 of the cogwheel RD to allow a thrust force of the cogwheel RD on the toothed bar in a first advancement direction S1 oriented longitudinally to the elongate member OL.

Advantageously, and as notably illustrated in the various embodiments, the teeth of said at least one toothed bar are preferably devoid of functional bearing surfaces configured to allow a thrust force of the cogwheel RD on said at least one toothed bar in a second advancement direction S2, opposite the first advancement direction S1.

Generally, the profile of beam 2 comprises longitudinal fold lines PL1 to PL16 extending parallel to each other along the elongate member OL. The longitudinal fold lines PL1 to PL16 define the angles of the profile cross-section.

Generally, and as illustrated in FIG. 2a, the tubular cross-section profile can be closed. In such a case the tabs 3 can typically be folded outwards, on the side opposite the hollow part of the profile.

The present disclosure does not exclude the tabs 3 being folded towards the inside of the hollow part of a semi-tubular cross-section profile, when the profile allows the cogwheel to be accommodated in the hollow part of the profile.

Generally, the tabs 3 are adjacent to the wall P_{OV} of the profile having said openings Ov, and which typically extends along the elongate member. The wall P_{OV} can typically be a flat wall when the elongate member is rectilinear, which extends along the YZ directions in particular in FIG. 2, when the Z direction extends parallel to the longitudinal axis of the elongate member and therefore to the longitudinal fold lines PL1 to PL16.

Generally, the tabs are adjacent to the profile, at the upper edges of the opening, via transverse fold lines PLD1 oriented substantially transversely to the longitudinal fold lines, PL1 to PL16, namely along the Y direction, in particular in FIG. 2a.

The transverse fold lines PLD1 are parallel to each other and are typically distributed along the length of said elongate member OL, and at a spacing corresponding to the tooth pitch “p” between two successive first teeth D1.

Generally, the tabs 3 each have at least one main part 30 each extending in a direction D3, from a proximal end Ep3 of one of the transverse fold lines PLD1 to a distal end Ed3. The distal end Ed3 is free and as illustrated in FIG. 2c or FIG. 2d. Direction D3 is substantially perpendicular to the transverse direction of the transverse fold line PLD1. The main portion 20 further extends, in the transverse direction, along a dimension corresponding to the transverse fold line.

This main portion 30 defines the upper functional bearing surface SAP of the first tooth D1 configured to engage with the second teeth D2 of the cogwheel. The meshing between the functional bearing surface SAP and the second teeth D2 of the cogwheel is preferably a rolling meshing between a tooth profile in a circle involute of the set of teeth of the cogwheel and the functional bearing surface SAP of the tab 3.

The width-wise dimension of the functional bearing surface SAP can typically be, in the transverse direction Y, greater than or equal to the dimension of the teeth of said at least one toothed bar in this transverse direction Y.

Generally, said beam 3 may be vertical, or at least inclined relative to the horizontal and be arranged in a direction so that the tabs 3 are oriented in the downward direction of the beam, from said proximal end Ep3 to the distal end Ed3. The functional bearing surface SAP is then arranged above said tab. The transverse fold line PLD1 then extends substantially along the upper edge of the opening OV from which the main portion 30 of the tab 3 originates. The gravity exerted on the cogwheel RD (or on the motorized carriage incorporating the cogwheel RD) holds at least one of the second teeth D2 of the cogwheel RD against the functional bearing surface SAP of one of the tabs 3 of the first teeth D1 of the elongate member OG, and whatever the rotation direction of the cogwheel, whether the motorized carriage moves upwards or downwards along the elongate member OL.

The angle S3 between the direction D3 of the main portion 30 of the tab 3, and the longitudinal direction of the beam is less than 90°, typically between 50 and 80°, or even between 65° and 75°, typically 70° and so that the pressure angle α, complementary to the angle S3, is typically between 10° and 40°, or even between 15° and 25°, and is for example typically 20°.

FIG. 1 gives an embodiment for which each tab 3 forming a first tooth D1 is adjacent to the beam profile, only via the transverse fold line PLD1. FIG. 1b is a schematic view of the U-shaped cutout in the wall P_{OV} of the profile provided with the openings, allowing a tab 3 to be produced, the cutout comprising, arranged in a U-shape, a lower cutting line CT and two lateral cutting lines CT, allowing, during stamping, the production of the tab by the transverse fold line PLD1, connecting the two ends of the U.

Such an embodiment, however, has limitations in terms of load transmitted to the tabs 3, and in particular of mechanical fatigue.

In use, the repeated passages of the cogwheel RD bearing on the functional bearing surfaces SAP and the loads thereby applied to the tabs 3 tend to unfold the tabs, which will deform over time towards the openings OV, with an undesired increase in the pressure angle α.

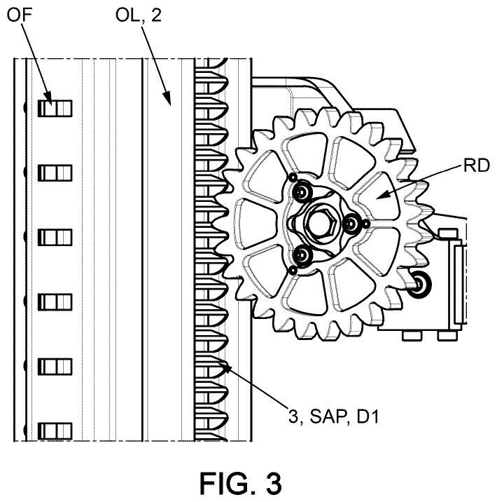

The embodiments illustrated in FIGS. 2 to 4 make it possible to significantly improve the situation and offer better performance in terms of load resistance and wear resistance.

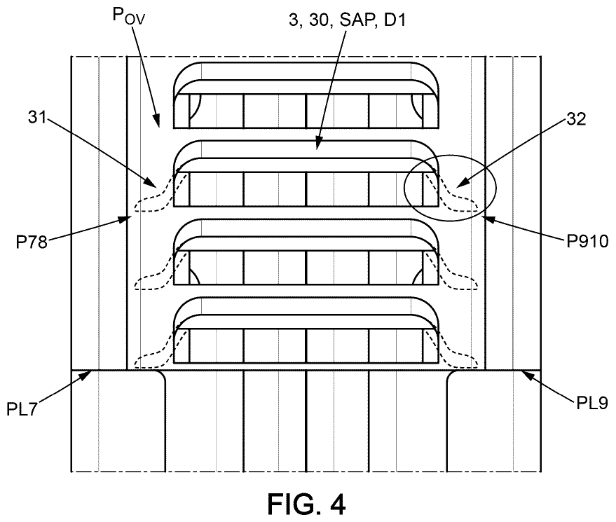

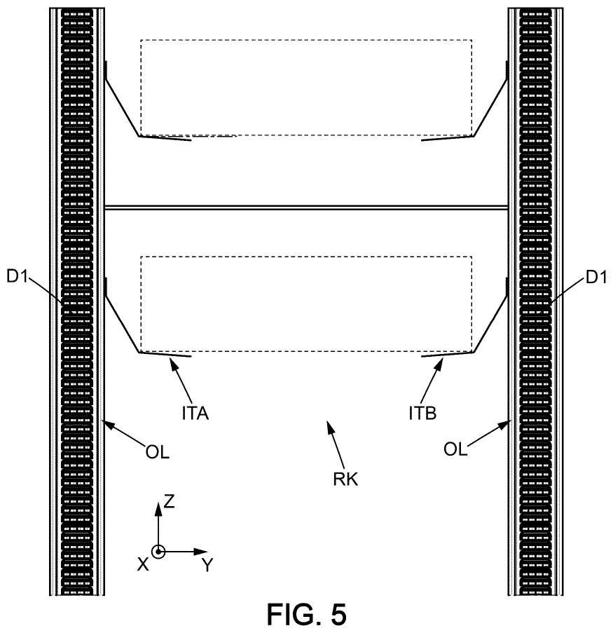

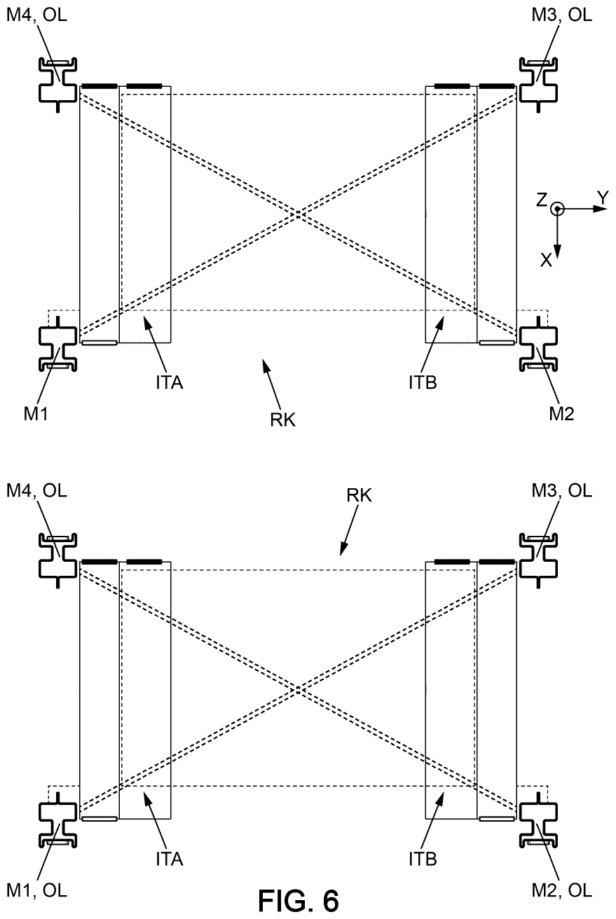

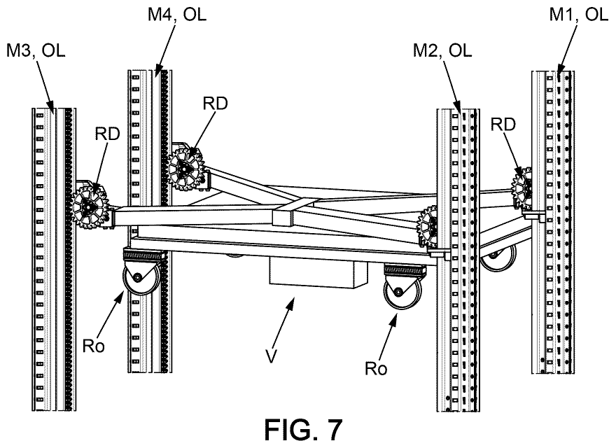

To this end, the tab 3 comprises, in addition to said main portion 30 defining the functional bearing surface SAP, at least one supporting portion, extending the main portion 30 laterally on one side of the main portion, or preferably two supporting portions 31, 32 extending the main portion 30 laterally respectively on both sides of the main portion and 30, and as illustrated in FIG. 2b or in FIG. 4, as an example.

The supporting portion, or each of the two supporting portions 31, 32, projects from the main portion 30 of the tab 3, on the side opposite the functional bearing surface SAP to constitute a reinforcement means between the main portion 30 and the profile.

Such a reinforcement means opposes the tab 3 bending when the upper functional bearing surface SAP undergoes a force transmitted by the second teeth D2 of the cogwheel RD. In the figures it can be seen that the profile of the tab (comprising the main portion 30 and the two supporting portions 31, 32) forms an arch when viewed along direction d3.

According to an embodiment, illustrated for information purposes in FIGS. 2, 2a, 2b, 2c, the supporting portion, or all or part of the supporting portions 31, 32 connect(s) the main portion 30 of the tab 3 to the wall P_{OV} of the profile provided with the openings OV which is a flat wall.

Generally, and as illustrated for information purposes in FIG. 2b, the main portion 30 can be extended laterally by:
a first supporting portion 31 of the tab, connecting a first lateral edge to the main portion 30 to the wall P_{OV},
a second supporting portion 32 of the tab, connecting a second lateral edge to the wall P_{OV}.

The dimension separating the first supporting portion 31 and the second supporting portion 32, delimiting the dimension of the main portion 30 of the tab 3 in this transverse direction, may typically be between 10 mm and 100 mm.

Generally, the main portion extends via the transverse fold line PLD1 which defines the upper edge of the opening OV, while the first supporting portion 31 extends via a first lateral fold line PLL1, which defines a first lateral edge of the opening Ov, and the second supporting portion extends via a second lateral fold line PLL2 which defines a second lateral edge of the opening Ov.

FIG. 2d is a schematic view of the cutout in the wall of the profile provided with the openings, allowing a tab to be provided, the cutout consisting of a lower cutting line CT, allowing, during stamping, the formation of the tab by a transverse fold line PLD1 and two lateral fold lines PLL1, PLL2, respectively connecting one end of the transverse fold line PLD1 to the lower cutting line PLD1.

According to an embodiment illustrated in particular in FIG. 2b, the upper edge of the opening OV formed by the transverse fold line, the first lateral edge of the opening formed by the first lateral fold line PLL1 and the second lateral edge of the opening formed by the second lateral fold line PLL2, as well as the lower edge are contained in the plane of the wall P_{OV} which is a flat wall P89 which can be a flat wall P89 laterally delimited by the fold lines PL8 and PL9 according to the illustrated embodiment.

According to another embodiment, visible in FIG. 4, the wall P_{OV} of the profile provided with the openings OV is only partially contained in the flat wall P89, delimited between the longitudinal fold referenced PL8 and the longitudinal fold referenced PL9 in FIG. 2b.

The wall P_{OV} of the profile provided with the openings OV is thus extended, on either side of the main portion 30 of the tabs 3, by two side walls P78, P910 extending in projection from the flat wall P89, on the same side as the tabs 3, the two side walls P78, P910 adjoining the tabs 3.

The side wall P78 extends projecting from the flat wall P89 via the longitudinal fold referenced PL8 and the side wall P910 extends projecting from the flat wall P89 via the longitudinal fold referenced PL9. In FIG. 2b, and generally speaking, the two side walls P78 and P910 are flat, parallel to each other, and extend substantially perpendicularly to the flat wall P79. According to the embodiment of FIG. 4, the lower cutting line CT extends over the entire transverse dimension of the wall 79 extending in the direction Y, extending into the two side walls P78, P910.

In such an embodiment according to FIG. 4, the two supporting portions 31, 32 respectively connect the main portion 30 to said two side walls P78, P910. Unlike the embodiment of FIG. 2, such an embodiment according to FIG. 4 involves an opening OV in the wall P_{OV} which extends not only into the planar wall P89, but which extends at least partially into the two side walls P78, P910. The upper edge of the opening OV which extends into the flat wall P89 and the lateral edges of the opening, which respectively extend into the two side walls P78 and P910, typically perpendicular to the flat wall P89, are therefore not contained in a same plane.

Generally, the beam profile can have other functions and in particular:
at least one series of fastening openings OF, distributed along the length of the upright, and allowing the beam to be fastened to other components of the storage rack, and/or
at least one guiding wall PG, typically parallel to the wall provided with the tabs, extending along the length of the profile, configured to cooperate with a guiding member OG such as a wheel, or a pad, coupled to a support of the cogwheel.

According to an embodiment, the guiding wall is materialized by a flank of a groove formed by the profile, extending along the length of the beam. In FIG. 2a, a first groove is materialized by three flat walls delimited between the longitudinal folds referenced PL11, PL12, PL13, PL14. The flat wall between the longitudinal folds PL12, PL13 forms the back of the groove, and the two opposite walls respectively delimited between the longitudinal folds PL11, PL12, on the one hand, and PL13, PL14, on the other hand, the two sides of the groove. The guiding wall PG is delimited between the folds PL11, PL12.

A second groove is materialized by three flat walls delimited between the longitudinal folds referenced PL3, PL4, PL5, PL6. The flat wall between the longitudinal folds PL4, PL5 forms the back of the groove, and the two opposite walls delimited between the longitudinal folds PL3, PL4, on the one hand, and PL5, PL6, on the other hand, the two sides of the groove. The guiding wall PG is delimited between the folds PL5, PL6.

According to an embodiment illustrated in FIG. 2a, the profile can advantageously have:
two series of fastening openings OF, the right and left series, diametrically opposed to the profile body, and/or,
two guiding walls PG, diametrically opposed.

The profile may have a plane of symmetry. The two sets of fastening openings OF are symmetrical to each other with respect to the plane of symmetry. The two guiding walls PG can be respectively symmetrical, with respect to this plane of symmetry of the profile. The plane of symmetry cuts the tabs 3 of the toothed bar in their middle.

The present disclosure also relates, according to another aspect, to a storage rack RK comprising a vertical structure comprising several uprights M1, M2, M3, M4 extending vertically, parallel to each other, and held together by a bracing system. The bracing system may include connecting cross members between the uprights, cross bracing, or the like.

FIGS. 5 and 6 illustrate a column of the storage rack which comprises several cells, distributed over to the height, configured for the superposition of several receptacles, such as bins, in the column. The vertical structure comprises four uprights M1, M2, M3, M4 which are elongate members according to the present disclosure.

Generally, according to the present disclosure, the uprights are formed in whole or in part by elongate members according to the present disclosure.

The elongate member can advantageously be formed by the metal profile forming the beam having a tubular or semi-tubular cross-section conferring structural resistance on the upright which is a single-piece component, typically produced by roll forming and cutting and stamping techniques, and as illustrated in the figures.

This disclosure does not exclude manufacturing the uprights in several parts, in particular in several profiles, and according to a not illustrated example.

Thus, and according to a second embodiment said elongate member is the metal profile which is a metal sheet such as a blade in which the tabs of said at least one toothed bar are formed. It is then a non-structural component compared to a tubular cross-section or semi-tubular cross-section beam. Such an elongate member can be directly produced by cutting and stamping so as to produce the tabs, preferably without requiring a roll forming operation.

Thus, the present disclosure also relates, according to a second embodiment, to an upright assembly comprising:
an elongate member according to the present disclosure, wherein the profile is the metal sheet provided with the tabs of said at least one toothed bar,
a second upright profile, structural, typically tubular or semi-tubular,

The metal sheet provided with the toothed bar is longitudinally fastened to the second structural upright profile, in particular by any known techniques such as welding, crimping, rivets. According to this variant, the profile is a substantially flat profile.

The present disclosure thus also relates to a storage rack comprising a vertical structure comprising several uprights M1, M2, M3, M4 extending vertically, parallel to each other, and held together by a bracing system, and wherein the uprights are formed in whole or in part by upright assemblies according to the present disclosure.

Thus, generally, the storage rack is configured to support a plurality of receptacles RC superimposed one over the other.

To this end, said storage rack typically comprises a plurality of pairs of mechanical interfaces which are fastened to the uprights M1, M2, M3, M4, distributed along the height of the rack to form several cells, each pair of interfaces comprising:
a first interface ITA fastened to at least two uprights M1, M2 of the vertical structure, cantilevered from the two uprights
a second interface ITB fastened to at least two other uprights M3, M4 of the vertical structure, cantilevered from the other two uprights.

Generally, and as visible in FIGS. 5 and 6, supporting portions of the first interface ITA and the second interface ITB are oriented towards each other in cantilevered manner from the uprights, configured to provide support for a receptacle RC supported by the two supporting portions of the two interfaces on both sides of the receptacle.

Generally, each mechanical interface comprises the following three successive portions:
an upper, vertical fastening portion, fastened to the uprights, to the fastening openings, by fastening tabs, or rivets,
a centering portion
the supporting portion.

The centering portion has a greater inclination than the supporting portion and is configured to ensure the load is centered, in the transverse direction Y, with respect to a median vertical plane between the two mechanical interfaces ITA and ITB. The three portions of the mechanical interface are typically produced by shaping a sheet metal via a first fold line, extending along the X direction, delimiting the fastening portion and the centering portion, and a second fold line, in parallel, delimiting the centering portion and the supporting portion.

The present disclosure relates to a transport and storage system comprising a storage rack according to the present disclosure and at least a vehicle V, typically an AGV, comprising a chassis, incorporating climbing means.

The climbing means comprise one or more motorized cogwheels RD configured to ensure the movement of the vehicle along at least one of the uprights M1, M2, M3, M4 of the vertical structure of the storage rack, upwards or downwards.

The cogwheel (or each cogwheel RD) transforms a rotational movement of the cogwheel(s) RD into a movement of the vehicle along said elongate member(s) OL by meshing the first teeth D1 of the toothed bar, and the second teeth D2 of the cogwheel RD, the first teeth advantageously being constituted by the tabs 3 in a single piece with the body of the beam profile 2.

The vehicle V may comprise a deployable loading/unloading system configured to:
load a receptacle from a first retracted position above the chassis to a second deployed position for which the receptacle is simultaneously bearing on the first interface and the second interface, or
take out a receptacle from the second position bearing on the first interface and the second interface of a pair of interfaces and load it into the first retracted position.

Such a loading/unloading system is not described in detail because it is known per se to the skilled person, such as for example from document WO 2019/072432.

Generally, the vehicle can comprise an uncoupling mechanism configured to move the cogwheel(s) RD of the climbing means of the vehicle from a coupled position for which the first teeth D1 of the elongate member OL secured to the rack upright and the second teeth D2 of the cogwheel RD are engaged, to an uncoupled position for which the cogwheel(s) RD provided with the second teeth D2, on the one hand, and the elongate members OL provided with the first teeth D1, on the other hand, are spaced apart with escapement between the first teeth D1 and the second teeth D2.

The vehicle V can comprise rolling means Ro for rolling on a horizontal surface, allowing the vehicle V to move on the horizontal surface in said uncoupled position, once the vehicle is separated from the vertical structure of the storage rack.

The horizontal surface can be the floor on which the base of the storage rack uprights bears, or it can be a ceiling at a height above the rack structure.

The rolling means may cooperate with guiding rails, following a direction of the horizontal surface, or following two distinct directions of the horizontal surface, or the rolling means may be configured to operate in open field on the horizontal surface, i.e. without guiding rails, and comprise motorized rollers.

Preferably, the vehicle comprises means for changing the direction of the vehicle movement on the horizontal surface. Thus, the vehicle is preferably configured to move along the two dimensions of the horizontal surface, in the uncoupled position of the uncoupling mechanism, then after coupling the cogwheel and the toothed bar to vertically move along the structure of the rack by motorized rotation of the cogwheel which cooperates with the set of teeth formed by the tabs 3 of the toothed bar to move upwards or downwards.

Le vehicle can be equipped with a guiding system comprising a guiding member OG, such as a bearing wheel, or a sliding pad, cooperating with said guiding wall PG of said profile of said elongate member.

The guiding system is configured so that the cooperation of the guiding member OG against the guiding wall PG ensures that the first teeth D1 of the toothed bar and the second teeth D2 of the cogwheel RD are kept in engagement.

Generally, and as illustrated in FIG. 2d, the cogwheel RD or each cogwheel can be articulated along the rotation axis A_{R} on a support S of the vehicle V. When guided, the guiding member OG, in particular the wheel, can be articulated along a rotation axis parallel to the rotation axis of the cogwheel.

The guiding wall PG is typically parallel to the wall P_{OV} provided with the openings when the wall P_{OV} is flat, or even parallel to a central part of the wall (i.e., the flat wall P89) when the wall P_{OV} extends laterally in projection by the side walls P78, P910.

The present disclosure further relates to a method for manufacturing an elongate member according to the present disclosure, an upright assembly according to the present disclosure, a storage rack according to the present disclosure, or a transport and storage system, wherein the profile forming the elongate member OL is produced, possibly when having a tubular or semi-tubular cross-section, by roll forming techniques, and said folded tabs 3 are produced from the material of the openings OV in the wall P_{OV} of the profile by cutting and stamping techniques.

### LIST OF REFERENCE SIGNS

1. Cogwheel and toothed bar system,
2. Beam (elongate member),
3. Tabs,
30. Main portion,
31, 32. Supporting portions
SAP. Bearing surface
OL. Elongate member,
D1. First teeth (elongate member),
RD. Cogwheel,
D2. Second teeth (cogwheel)
OV. Openings
P_{OV}. Wall provided with the openings,
P78, P910. Walls extending the wall provided with the openings
PL1 to PL16. Longitudinal fold lines,
PLD1. Transverse fold lines,
SAP. Functional bearing surfaces (first teeth);
OG. Guiding member,
S. Support (provided with the cogwheel and the guiding member),
PG. Guiding wall,
RK. Storage rack,
RC. Receptacles,
M1, M3, M3, M4. Uprights
ITA, ITB. First and second mechanical interface.

1-15. (canceled)

16. A storage rack comprising a vertical structure comprising several uprights extending vertically, parallel to each other, and held together by a bracing system, and wherein the uprights are formed in whole or in part by elongate members, wherein each elongate member has at least one toothed bar intended to mesh with a cogwheel pivoting around a rotation axis of the cogwheel, said at least one toothed bar comprising first teeth distributed along a lengthwise direction of said elongate member, intended to mesh with second teeth over a diameter of the cogwheel,
wherein the elongate member is formed by a metal profile and wherein the first teeth are formed by folded tabs which are produced by folding the material of the metal profile coming from a series of openings in a wall of the profile distributed along the lengthwise direction of said elongate member, said tabs projecting from said wall, on one side of the wall.

17. The storage rack according to claim 16, wherein said elongate member is formed by a metal profile forming a beam having a tubular or semi-tubular cross-section, conferring structural resistance on the upright which is a single-piece component.

18. The storage rack according to claim 16, wherein the uprights are formed in whole or in part by upright assemblies, each upright assembly comprising:
said elongate member formed by the metal profile which is a metal sheet such as a blade, in which said tabs of the toothed bar are formed,
a second upright profile, structural, tubular or semi-tubular,
and wherein the metal sheet of the elongate member provided with said at least one toothed bar is fastened longitudinally to the second structural upright profile.

19. The storage rack according to claim 16, wherein the folded tabs are inclined in the same direction relative to the longitudinal direction of the elongate member, the tabs defining dorsal surfaces facing the openings, and functional bearing surfaces, opposite the dorsal surfaces, configured to engage the second teeth of the cogwheel to allow a thrust force of the cogwheel on said at least one toothed bar in a first advancement direction along the toothed bar, and wherein the teeth of said at least one toothed bar are devoid of functional bearing surfaces configured to allow a thrust force of the cogwheel on said at least one toothed bar in a second advancement direction, opposite the first advancement direction.

20. The storage rack according to claim 16, wherein the tabs are adjacent the wall of the profile having said openings, said tabs being adjacent by transverse fold lines that are oriented substantially transversely to the longitudinal direction of the elongate member, the transverse fold lines being parallel to each other, distributed along the length of said elongate member and wherein the tabs have at least one main part each extending in a direction D3, perpendicular to the transverse fold line, from a proximal end of the transverse fold line to a distal end, defining a functional bearing surface configured to engage with the second teeth of the cogwheel.

21. The storage rack according to claim 19, wherein the elongate member is arranged so that the tabs of said at least one toothed bar are oriented in the downward direction of the elongate member, from said proximal end to the free distal end, said functional bearing surfaces being arranged above the tabs, configured so that the gravity exerted on the cogwheel holds at least one of the second teeth of the cogwheel against the functional bearing surface of one of the tabs of the first teeth of the elongate member.

22. The storage rack according to claim 21, wherein the angle S3 between the direction D3 of the main portion of the tab, and the longitudinal direction of the elongate member is less than 90°, and so that the complementary pressure angle α is between 10° and 40°.

23. The storage rack according to claim 20, wherein the tab comprises, in addition to said main portion defining the functional bearing surface, at least one supporting portion, extending the main portion laterally on one side of the main portion, or two supporting portions extending the main portion laterally respectively on both sides of the main portion wherein the supporting portion, or each of the two supporting portions extend(s) projecting from the main portion of the tab, on the side opposite the functional bearing surface to constitute a reinforcement between the main portion and the profile, the reinforcement opposing the tab bending when the upper functional bearing surface undergoes a force transmitted by the second teeth of the cogwheel.

24. The storage rack according to claim 23, wherein the supporting portion, or all or part of the supporting portions connect(s) the main portion of the tab to the wall of the profile provided with the openings which is a flat wall.

25. The storage rack according to claim 23, wherein the wall of the profile provided with the openings is partially contained in a plane by defining a flat wall, the wall provided with the openings being extended on either side of the tabs, by two side walls extending in projection from the flat wall, projecting on the same side as the tabs, the two side walls adjoining the tabs,
and wherein the two supporting portions respectively connect the main portion to said two side walls.

26. A transport and storage system comprising a storage rack according to claim 16 and at least one vehicle comprising a chassis, incorporating a climbing mechanism, comprising one or more motorized cogwheels configured to perform the movement of the vehicle along the uprights of the vertical structure of the storage rack, upwards or downwards, by transforming a rotational movement of the cogwheel(s) into a movement of the vehicle along said elongate member(s) by the first teeth of said at least one toothed bar meshing with the second teeth of the cogwheel.

27. The transport and storage system according to claim 26, wherein the storage rack is configured to support a plurality of receptacles, said storage rack comprising a plurality of pairs of mechanical interfaces which are fastened to the uprights, distributed along the height of the rack to form several storage cells, each pair of interfaces comprising:
a first interface fastened to at least two uprights of the vertical structure, cantilevered from the two uprights,
a second interface fastened to at least two other uprights of the vertical structure, cantilevered from the other two uprights,
and wherein supporting portions of the first interface and the second interface are oriented towards each other in cantilevered manner from the uprights, configured to provide support for a receptacle supported by the two supporting portions of the two interfaces on both sides of the receptacle, and wherein the vehicle comprises a deployable loading/unloading system configured to:
load a receptacle from a first retracted position above the chassis to a second deployed position for which the receptacle is simultaneously bearing on the first interface and the second interface, or
take out a receptacle from the second position bearing on the first interface and the second interface of a pair of interfaces and load it into the first retracted position.

28. The transport and storage system according to claim 26, wherein the vehicle comprises an uncoupling mechanism configured to move the cogwheel(s) of the climbing mechanism of the vehicle from a coupled position for which the first teeth of the elongate member and the second teeth of the cogwheel are engaged, to an uncoupled position for which the cogwheel(s) provided with the second teeth, on the one hand, and the elongate members provided with the first teeth, on the other hand, are spaced apart with escapement between the first teeth and the second teeth, and wherein the vehicle comprises a rolling mechanism for rolling on a horizontal surface, allowing the vehicle to move on the horizontal surface in said uncoupled position, once the vehicle is separated from the vertical structure of the storage rack.

29. The transport and storage system according to claim 26, wherein the cogwheel is articulated along the rotation axis on a support of the vehicle,
and wherein the vehicle is equipped with a guiding system comprising a guiding member, such as a bearing roller, or a sliding pad, cooperating with a guiding wall of said profile of said elongate member,
and wherein the guiding system is configured so that the cooperation of the guiding member against the guiding wall ensures that the first teeth of said at least one toothed bar and the second teeth of the cogwheel are kept in engagement.

30. A method for manufacturing a storage rack according to claim 16, wherein the profile forming the elongate member is produced, by roll forming techniques, and said folded tabs are produced from the material of the openings in the wall of the profile by cutting and stamping techniques.
